(19) United States
(12) Patent Application Publication
(10) Pub. No.: US 2020/0102104 A1
(43) Pub. Date: Apr. 2, 2020

(54) AUTOMATIC TYING MACHINE FOR CROPS, BUNDLES, OR BUNDLED PRODUCTS

(71) Applicant: Yong Jin KIM, Daejeon (KR)

(72) Inventor: Yong Jin KIM, Daejeon (KR)

(21) Appl. No.: 16/616,988

(22) PCT Filed: Nov. 27, 2017
(86) PCT No.: PCT/KR2017/013594

§ 371 Date: Nov. 26, 2019

(30) Foreign Application Priority Data
Jun. 5, 2017 (KR) 10-2017-0069497

(51) Int. Cl. B65B 13/26; A01F 25/00; B65B 13/02; B65B 13/18; B65B 61/00

(52) U.S. Cl. CPC B65B 13/265; A01F 25/00; B65B 61/005; B65B 13/187; B65B 13/025

(57) ABSTRACT

The present invention relates to an automatic tying machine for automatically tying binding wires in order to fix crops in a farmhouse or tie bundles or bundled products during distribution. More specifically, the present invention relates to an automatic tying machine which can use binding wires of different thicknesses, in which after a binding wire is drawn into a slot of a whirling binding wire guide device, the binding wire does not slip off from the slot during rotation of a slewing gear to prevent malfunctioning of the automatic tying machine for crops, such that it is possible to accurately and quickly tie crops, bundles or bundled products. Due to these features, the automatic tying machine has remarkable effects that can improve the productivity of work of tying crops, bundles or bundled products and improve work convenience.

### TECHNICAL FIELD

The present invention relates to an automatic tying machine for automatically tying crops on a farm or bundles or bundled products for distribution.

### BACKGROUND ART

While crops grown, the stems and branches may be snapped or bent or even collapsed by heavy fruit or rain and winds. To prevent this, crops are firmly tied to supports or to each other directly or via strings.

Garden plants or vine crops grow with long thin stems and, if neglected, their stems and branches may be bent or broken by their own weight or rain and winds and even fall down to the ground, failing to grow properly. Thus, if tied to supports, crops may grow upward.

Tied or bundled crops, products, or garbage bags are selling on the market.

Conventionally, tying machines for gardening are used to tape the stems and branches of plants to supports and guide strings, helping crops grow properly. Korean Patent Nos. 10-0347635 and 10-0779500 disclose tying machines for gardening.

Meanwhile, Korean Patent No. 10-1509623 (issued on Apr. 1, 2015) discloses a tying machine for farming, in which there is an iron pin supply 3 for loading an iron pin bundle 10 of several tying iron pins 10a which are tightly attached side-by-side by an adhesive 10b inside a tying main body 1. The iron pin supply 3 has an end with an iron pin outlet 3a and an opposite end with a spring 11 for pushing the iron pin bundle towards the iron pin outlet 3a. Inside the iron pin supply 3 is formed an iron pin cover 30. An injection hole 30a which an iron pin extrusion plate 12 enters or exits is formed at an end. The iron pin extrusion plate 12 is attached perpendicular to the tying main body so that one tying iron pin may be pushed out through the iron pin extrusion plate inlet. A tape cutting chamber 3c and a tape discharging chamber 8 are provided at the end of the tying main body. At the rear end of the tying main body 1 is provided a tape receiving chamber 2a in which a tape reel is mounted. A tying tape 20 is supplied to the tape discharging chamber 8. On the top surface of the tying main body 1 is an elevation operating body 5 connected via a rotational shaft 5a. The elevation operating body 5 is operated by an operation lever 4 and returned by a returning spring 501. A tying iron pin bending device 5b and a tape pulling needle 601 are provided at an end of the elevation operating body 5. The elevation operating body descends, allowing an operation plate 603 of the tape pulling device 6 to press an operation protrusion 100 of the tying main body 1 so that the pulling needle is operated inwards to punch an end of the tying tape in the tape discharging chamber, thereby forming a tying ring 20a. Both ends of the tying ring are coupled together by the tying iron pin 10a, and the outside of the coupled portion 20b is cut off by a cutter 7. Thus, the tying work may be repeatedly performed. An iron pin waiting groove 3b is formed in the inner surface of the iron pin supply-side boundary in the iron pin outlet 3a of the iron pin supply 3. An iron pin separation protrusion 12a is formed which is rendered to have a width enough to push out one iron pin by spacing a predetermined distance away from the end of the iron pin extrusion plate 12 in the inner surface of the iron pin extrusion plate 12. A guide groove 30b is formed in the center of the inlet 30a formed at the end of the iron pin cover 30 to allow the iron pin separation protrusion to pass through.

Korean Patent No. 10-0860377 (issued on Sep. 19, 2008) of the inventor discloses, as shown in FIGS. 1 to 8, an automatic crop tying machine including a case 100 with a front opening through which crops to be tied are inserted and a handle 102, a tying string supply 200 provided behind the case 100 to continuously supply a tying string which is wound around a cylindrical reel, a tying string feeder 300 provided inside the case 100 to supply a predetermined length of the tying string to the front opening, a rotational tying string guide 400 for winding the tying string supplied from the tying string feeder 300 around crops, a tying string cutter 500 for cutting the tying string wound around the crops, and a tying string twister 600 for twisting the tying string cut by the tying string cutter 500.

The case 100 may be shaped as a pistol. Inside the case 100 is provided a driving motor 120 to generate mechanical power for automated tying with the tying string. A power supply 104 is installed at the handle 102 to supply power to the driving motor 120. Power typically used for motorized or power tools is supplied to the power supply 104. In other words, a power cable or charger is used.

In the tying string supply 200, the tying string is wound around the cylindrical reel. The reel is hinged at the center thereof so that the tying string is smoothly reeled out and supplied. A one-way clutch bearing is provided to prevent the reel from rotating reversely so that the tying string is reeled back in.

The tying string feeder 300 is provided on the left side of the handle 102 and at the rear of the handle 102 which is on the side of the rotational tying string guide 400. This allows the tying string feeder 300 to be positioned close to the opening so that the tying string is supplied to the front with the tying string tightened. The tying string feeder 300 includes a rack 310 provided on an operation lever 110 of the handle 102, a driving roller 320 with a pinion 321 which is engaged with the rack 310 to rotate, and a follower roller 330 contacting and interworking with the driving roller 320.

The case 100 includes a guide table 311 for guiding the rack 310 to allow the rack 310 to smoothly move. An elastic member (not shown) may be provided in the follower roller 330 to increase the contact to the driving roller 320.

The rotational tying string guider 400 is installed on the left side of the figure. In other words, the rotating gear 420 has a front opening to allow crops to be positioned inside the rotating gear 420. If crops to be tied are positioned inside the rotating gear 420 which has the crop guiding opening 410, the rotating gear revolves around the crops while biting the tying string.

The tying string cutter 500 is positioned behind the rotational tying string guider 400 as shown in FIGS. 1 to 4. A cutter blade 510 is fastened to the twist shaft 630 of the tying string twister 600. This eliminates the need for a mechanical force transferring device and a separate shaft for installation of the cutter blade 510. The tying string cutter 500 cuts the tying string wound around the crops.

The tying string twister 600 twists the tying string wound around the crops. After the tying string is cut by the cutter blade 510 of the tying string cutter 500, the twister 640 operates. This is defined by a pounder 604 with a protrusion 604a formed in the twister 640 to be spaced at a predetermined gap from a stopping pin 631 formed in the twister shaft 630.

In other words, as shown in FIGS. 3 and 4, as the driving motor 120 is driven, the driving gear 463 rotates the twister driven gear 632 and, as the twister driven gear 632 rotates, the twister shaft 630 rotates. As the twister shaft 630 rotates, the cutter blade 510 of the tying string cutter 500 is rotated, cutting the tying string. The tying string cut by the cutter blade 510 of the tying string cutter 500 is twisted as the twister 640 rotates. After the cutter blade 510 of the tying string cutter 500 rotates, the rotation of the twister 640 of the tying string twister 600 is defined by the pounder 604 formed in the twister 640 and the stopping pin 631 formed in the twister shaft 630.

The description is made with reference to FIGS. 1 and 2, focusing on the driving motor 120 that drives the tying string twister 600 and the tying string guider 400. A driven bevel gear 450 is provided which is engaged with the driving bevel gear 460 formed on the shaft of the driving motor 120 in the case 100 to transfer mechanical power.

There is also provided a timing driving gear 451 which is integrally formed with the driven bevel gear 450. A timing belt 440 is mounted which transfers the rotational force of the timing driving gear 451. A first and second timing gear 431 and 431′ is provided adjacent to the rotating gear 420. The rotational tying string guider 400 rotates the rotating gear 420 which has the crop guiding opening 410 for receiving crops by the first and second pinions 432 and 432′ which are integrally formed with the first and second timing gears 431 and 431′.

The rotating gear 420 has a fixing slot 421 for preventing the tying string from escaping off when the rotating gear 420 rotates in the area adjacent to the tying string cutter 500 as shown in FIG. 5 and guides the tying string. As the rotating gear 420 rotates, the crops are twined.

FIG. 6 is a partially enlarged view of FIG. 2 which shows the tying string feeder 300. The tying string feeder 300 is operated by the operation lever 110 which is shaped as a trigger in the handle 102. The operation lever 110 has an elastic member 162 returnable as shown in the drawings.

As shown in FIG. 7, the operation lever 110 has the rack 310. The rack 310 interworks with the operation lever 110. As the rack 310 is moved, the driving roller 320 which has the pinion 321 engaged with the rack 310 is rotated. As the driving roller 320 rotates, the follower roller 330 is rotated while contacting the driving roller 320, so that the tying string is pulled along the guiding groove 150 and supplied forwards.

The operation lever 110 has a first switch 111 which contacts a sensor 140 to operate the driving motor 120 after supplying the tying string by moving the rack 310 to operate the tying string feeder 300. In other words, after the operation lever 110 is pulled so that the rack 310 rotates the driving roller 320 to thereby supply the tying string forwards, the first switch 111 contacts the sensor 140, driving the driving motor 120.

A second switch 130 is rotatably provided as shown in FIG. 8. After the rotating gear 420 is rotated, a protrusion 423 formed on the opposite surface of the rotating gear 420 touches an end of the second switch 130, so that the second switch 130 is rotated to contact the sensor 140 and is returned back to the original position by a returning spring (not shown) provided at the hinge which is the center of rotation. By the operation of the second switch 130, the sensor 140 drives the driving motor 120 reversely.

There are provided the tying string cutter 500 and the tying string twister 600 to cut and twist the tying string pulled out of the tying string feeder 300. More specifically, the tying string cutter 500 is provided on the twister shaft 630 of the tying string twister 600 and has the cutter blade 510 fastened to the twister shaft 630. The twister 640 has a plurality of wings. The tying string supplied from the feeder 300 is hung over any one wing and, as the rotating gar 420 rotates, the tying string is wound around the crops.

The tying string is hung over one wing of the twister 640 and, as the twister 640 rotates, the tying string is twisted.

In the automatic crop tying machine disclosed in Korean Patent No. 10-0860377 (issued on Sep. 19, 2008), the rotating gear 420 has the fixing slot 421 for preventing the tying string from escaping off when the rotating gear 420 rotates and guides the tying string. In this case, since the fixing slot 421 is fixed, it is impossible to use tying strings with various thicknesses. After the tying string is pulled into the fixing slot 421, when the rotating gear 420 rotates, the tying string may slide off fixing slot 421.

The inventors of the instant application have made a research effort to address the forgoing problems and completed the instant invention which includes a configuration of a slot 421 and a rotating gear 420 by which the tying string pulled into the slot 421 may be prevented from sliding off the slot 421 when the rotating gear 420 rotates and allows for use of various thicknesses of tying strings.

### DETAILED DESCRIPTION OF THE INVENTION

### Technical Problem

To address the foregoing problems, according to the present invention, there is provided an automatic tying machine, comprising a case having a front opening for inserting a crop, a bundle, or a bundled products, a tying string supply provided behind the case, a feeder providing a tying string of the tying string supply forward, a rotational tying string guide winding the tying string supplied from the feeder around the crop, bundle, or bundled product as a rotating gear is rotated by a driving motor, a tying string cutter cutting the tying string wound around the crop, bundle, or bundled product by the rotational tying string guide as the driving motor rotates reversely, and a tying string twister receiving a rotational force from the driving motor to twist both ends of the tying string cut by the tying string cutter. The automatic tying machine allows for use of various thicknesses of tying strings and may prevent the tying string pulled into the slot of the rotational tying string guider from sliding off the slot when the rotating gear rotates.

### Technical Solution

To achieve the above objects, an automatic tying machine comprises a case having a front opening for inserting a crop, a bundle, or a bundled products, a tying string supply provided behind the case, a feeder providing a tying string of the tying string supply forward, a rotational tying string guide winding the tying string supplied from the feeder around the crop, bundle, or bundled product as a rotating gear is rotated by a driving motor, a tying string cutter cutting the tying string wound around the crop, bundle, or bundled product by the rotational tying string guide as the driving motor rotates reversely, and a tying string twister receiving a rotational force from the driving motor to twist both ends of the tying string cut by the tying string cutter, wherein the rotational tying string guide includes the rotating gear, the rotating gear including a guide structure which is an opening for positioning the crop, bundle, or bundled product inside the rotating gear, wherein a fastening slot and a rotating slot are formed on the rotating gear in a direction opposite to the guide structure, and wherein when the crop, bundle, or bundled product is positioned in the guide structure, the fastening slot and rotating slot of the rotating gear rotate around the crop, bundle, or bundled product while biting the tying string, thereby tying the crop, bundle, or bundled product.

The fastening slot is fastened onto the rotating gear and is spaced by a gap for receiving the tying string under the rotating slot. The rotating slot is formed on the rotating gear and over the fastening slot to pivot on a pivot shaft. The rotating slot includes a tying string guide support and a tying string compressing part to prevent the tying string from sliding off when the tying string is wound around the crop, bundle, or bundled product. A stopper is provided to control rotation of the rotating slot.

The rotating slot is rotated to fit the thickness of the tying string to thereby guide various thicknesses of tying strings. The rotating slot compresses the tying string by the tying string compressing part to prevent the tying string from sliding off.

### Advantageous Effects

According to the present invention, the automatic tying machine allows for use of various thicknesses of tying strings and may prevent the tying string pulled into the slot of the rotational tying string guider from sliding off the slot when the rotating gear rotates. Thus, the automatic tying machine may be prevented from malfunctioning while automatically tying crops, bundles, or bundled products in a quick and precise manner, thereby enhancing productivity and work convenience in tying crops, bundles, or bundled products.

### BRIEF DESCRIPTION OF DRAWINGS

FIG. 1 is an exploded perspective view illustrating an automatic crop tying machine according to the inventor's prior patent;

FIG. 2 is an exploded front view illustrating the automatic crop tying machine according to the inventor's prior patent;

FIG. 3 is a partial detailed view illustrating the automatic crop tying machine according to the inventor's prior patent;

FIG. 4 is a front view illustrating the tying string twister and tying string cutter of the automatic crop tying machine according to the inventor's prior patent;

FIG. 5 is a perspective view illustrating the slot formed in the rotating gear of the automatic crop tying machine according to the inventor's prior patent;

FIG. 6 is a detailed view illustrating the feeder of the automatic crop tying machine according to the inventor's prior patent;

FIG. 7 is a perspective view illustrating the operation lever of the automatic crop tying machine according to the inventor's prior patent;

FIG. 8 is a view illustrating the operation of the second switch of the automatic crop tying machine according to the inventor's prior patent;

FIG. 9 is a perspective view illustrating the slot formed in the rotating gear according to the inventor's prior patent; and

FIG. 10 is a perspective view illustrating a slot formed in a rotating gear according to an embodiment of the present invention.

** Description of Reference Numbers **

| | |
|---|---|
| 100: | case |
| 110: | operation lever |
| 111: | first switch |
| 120: | driving motor |
| 130: | second switch |
| 140: | sensor |
| 200: | tying string supply |
| 300: | tying string feeder |
| 310: | rack |
| 320: | driving roller |
| 330: | follower roller |
| 400: | rotational tying string guide |
| 420: | rotating gear |
| 421: | fixing slot |
| 421′: | rotating slot |
| 424: | tying string guiding support |
| 425: | tying string compressing part |
| 426: | stopper |
| 427: | rotating shaft |
| 431, 431′: | first and second timing gears |
| 432, 432′: | first and second pinions |
| 440: | timing belt |
| 450: | driven bevel gear |
| 451: | timing driving gear |
| 460: | driving bevel gear |
| 500: | tying string cutter |
| 510: | cutting blade |
| 600: | tying string twister |
| 604: | pounder |
| 604a: | protrusion |
| 630: | twister shaft |
| 631: | stopping pin |
| 632: | twister driven gear |

### MODE FOR CARRYING OUT THE INVENTION

According to the present invention, there is provided an automatic tying machine, comprising a case having a front opening for inserting a crop, a bundle, or a bundled products, a tying string supply provided behind the case, a feeder providing a tying string of the tying string supply forward, a rotational tying string guide winding the tying string supplied from the feeder around the crop, bundle, or bundled product as a rotating gear is rotated by a driving motor, a tying string cutter cutting the tying string wound around the crop, bundle, or bundled product by the rotational tying string guide as the driving motor rotates reversely, and a tying string twister receiving a rotational force from the driving motor to twist both ends of the tying string cut by the tying string cutter, wherein the rotational tying string guide includes the rotating gear, the rotating gear including a guide structure which is an opening for positioning the crop, bundle, or bundled product inside the rotating gear, wherein a fastening slot and a rotating slot are formed on the rotating gear in a direction opposite to the guide structure, and wherein when the crop, bundle, or bundled product is positioned in the guide structure, the fastening slot and rotating slot of the rotating gear rotate around the crop, bundle, or bundled product while biting the tying string, thereby tying the crop, bundle, or bundled product.

The fastening slot is fastened onto the rotating gear and is spaced by a gap for receiving the tying string under the rotating slot. The rotating slot is formed on the rotating gear and over the fastening slot to pivot on a pivot shaft. The rotating slot includes a tying string guide support and a tying string compressing part to prevent the tying string from sliding off when the tying string is wound around the crop, bundle, or bundled product. A stopper is provided to control rotation of the rotating slot.

The rotating slot is rotated to fit the thickness of the tying string to thereby guide various thicknesses of tying strings. The rotating slot compresses the tying string by the tying string compressing part to prevent the tying string from sliding off.

Hereinafter, exemplary embodiments of the present invention will be described in detail with reference to the accompanying drawings to be easily practiced by one of ordinary skill in the art. However, the present invention may be implemented in other various forms and is not limited to the embodiments shown in the drawings.

According to the present invention, an automatic tying machine includes a case having a front opening for inserting a crop, a bundle, or a bundled products, a tying string supply provided behind the case, a feeder providing a tying string of the tying string supply forward, a rotational tying string guide winding the tying string supplied from the feeder around the crop, bundle, or bundled product as a rotating gear is rotated by a driving motor, a tying string cutter cutting the tying string wound around the crop, bundle, or bundled product by the rotational tying string guide as the driving motor rotates reversely, and a tying string twister receiving a rotational force from the driving motor to twist both ends of the tying string cut by the tying string cutter. The rotational tying string guide includes the rotating gear, the rotating gear including a guide structure which is an opening for positioning the crop, bundle, or bundled product inside the rotating gear. A fastening slot and a rotating slot are formed on the rotating gear in a direction opposite to the guide structure. When the crop, bundle, or bundled product is positioned in the guide structure, the fastening slot and rotating slot of the rotating gear rotate around the crop, bundle, or bundled product while biting the tying string, thereby tying the crop, bundle, or bundled product.

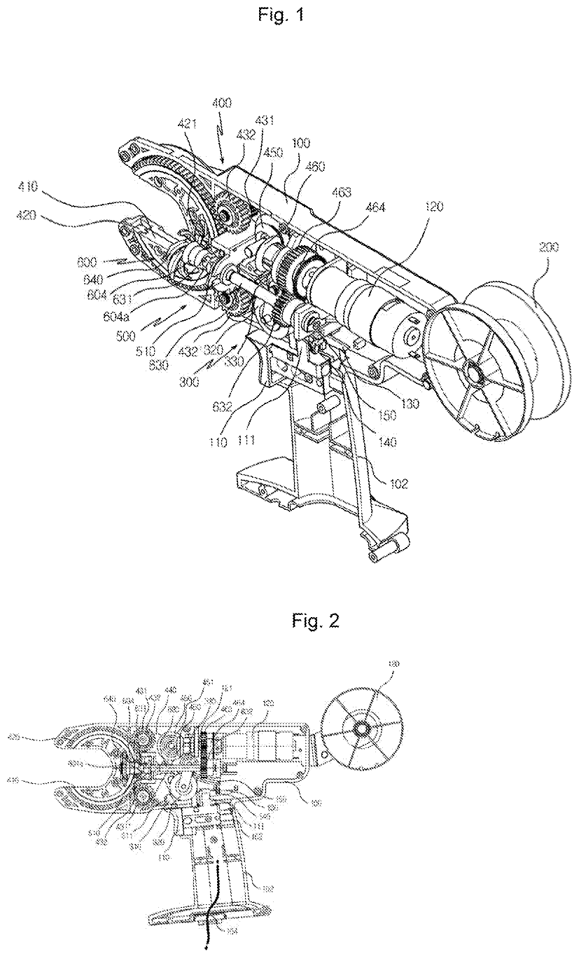

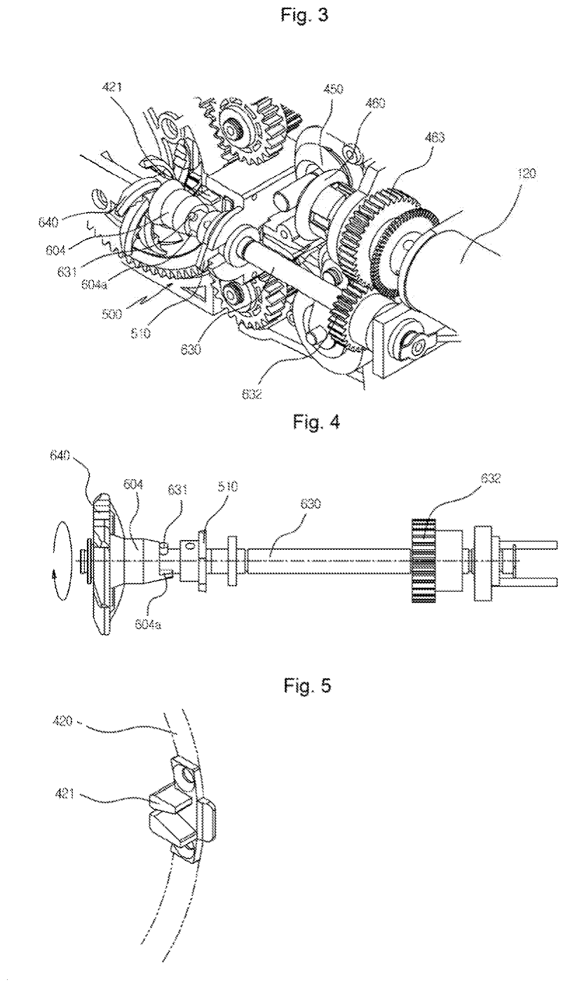

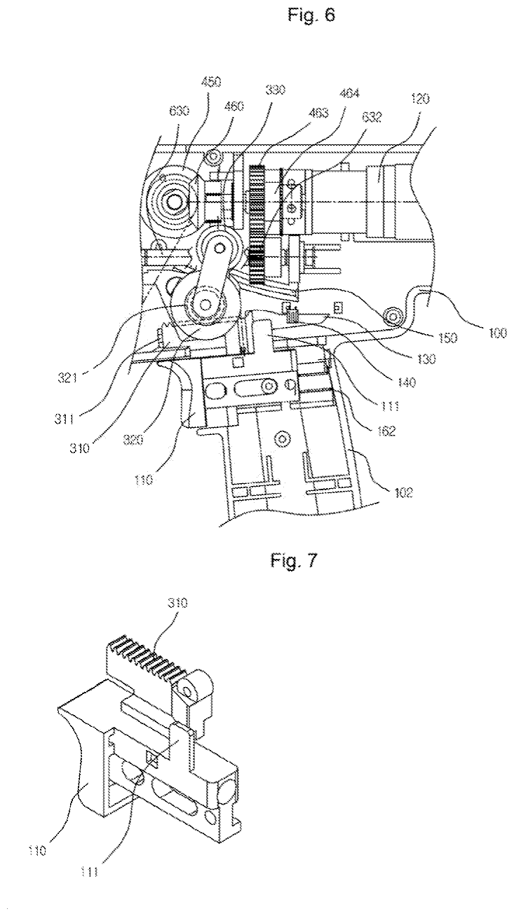

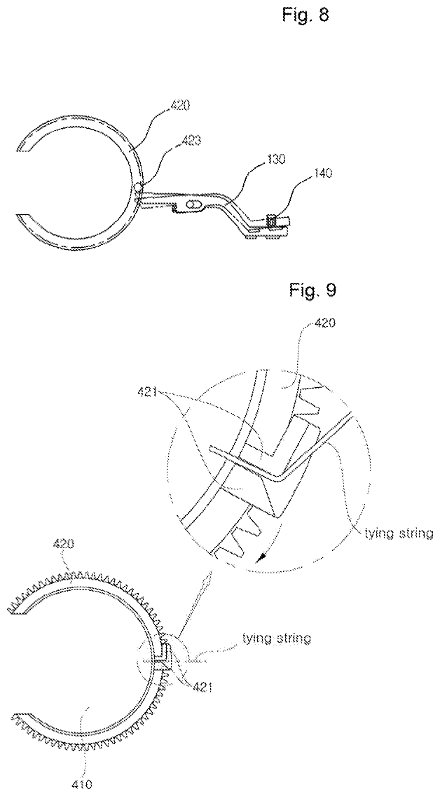

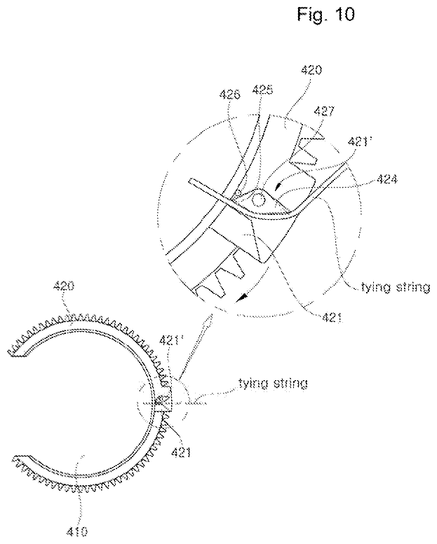

Referring to FIGS. 1 to 8, according to the present invention, an automatic tying machine includes a case 100 having a front opening for inserting a crop, a bundle, or a bundled products, a tying string supply 200 provided behind the case, a feeder 300 providing a tying string of the tying string supply forward, a rotational tying string guide 400 winding the tying string supplied from the feeder around the crop, bundle, or bundled product as a rotating gear is rotated by a driving motor, a tying string cutter 500 cutting the tying string wound around the crop, bundle, or bundled product by the rotational tying string guide as the driving motor rotates reversely, and a tying string twister 600 receiving a rotational force from the driving motor to twist both ends of the tying string cut by the tying string cutter. The rotational tying string guide 400 includes the rotating gear 420. The rotating gear 420 includes a guide structure 410 which is an opening for positioning the crop, bundle, or bundled product inside the rotating gear. A fastening slot 421 and a rotating slot 421′ are formed on the rotating gear in a direction opposite to the guide structure.

In this case, the fastening slot 421 is fastened onto the rotating gear 420 and is spaced by a gap for receiving the tying string under the rotating slot 421′. The rotating slot 421′ is formed on the rotating gear 420 and over the fastening slot 421 to pivot on a pivot shaft 427. The rotating slot 421′ includes a tying string guide support 424 and a tying string compressing part 425 to prevent the tying string from sliding off when the tying string is wound around the crop, bundle, or bundled product. A stopper 426 is provided to control rotation of the rotating slot 421′.

The rotating slot 421′ is rotated to fit the thickness of the tying string to thereby guide various thicknesses of tying strings. The rotating slot 421′ compresses the tying string by the tying string compressing part 425 to prevent the tying string from sliding off.

That is, the tying string guiding support 424 supports the tying string to allow the tying string to rotate around the crop, bundle, or bundled product. The tying string compressing part 425 compresses the tying string to prevent the tying string from sliding off.

According to the present invention, with the configuration of the fixing slot 421 and the rotating slot 421′, the automatic tying machine allows for use of various thicknesses of tying strings and may prevent the tying string pulled into the slot of the rotational tying string guider from sliding off the slot when the rotating gear rotates. Thus, the automatic tying machine may be prevented from malfunctioning while automatically tying crops, bundles, or bundled products in a quick and precise manner, thereby enhancing productivity and work convenience in tying crops, bundles, or bundled products.

The above-described embodiments are merely examples, and it will be appreciated by one of ordinary skill in the art various changes may be made thereto without departing from the scope of the present invention. Accordingly, the drawings are provided for illustrative purposes, but not to limit the scope of the present invention, and should be appreciated that the scope of the present invention is not limited by the drawings. The scope of the present invention should be construed by the following claims, and all technical spirits within equivalents thereof should be interpreted to belong to the scope of the present invention.

1. An automatic tying machine, comprising:
a case (100) having a front opening for inserting a crop, a bundle, or a bundled products;
a tying string supply (200) provided behind the case;
a feeder (300) providing a tying string of the tying string supply forward;
a rotational tying string guide (400) winding the tying string supplied from the feeder around the crop, bundle, or bundled product as a rotating gear is rotated by a driving motor;
a tying string cutter (500) cutting the tying string wound around the crop, bundle, or bundled product by the rotational tying string guide as the driving motor rotates reversely; and
a tying string twister (600) receiving a rotational force from the driving motor to twist both ends of the tying string cut by the tying string cutter, wherein the rotational tying string guide (400) includes the rotating gear (420), the rotating gear (420) including a guide structure (410) which is an opening for positioning the crop, bundle, or bundled product inside the rotating gear, wherein a fastening slot (421) and a rotating slot (421′) are formed on the rotating gear in a direction opposite to the guide structure, and wherein when the crop, bundle, or bundled product is positioned in the guide structure (410), the fastening slot (421) and rotating slot (421′) of the rotating gear (420) rotate around the crop, bundle, or bundled product while biting the tying string, thereby tying the crop, bundle, or bundled product.

2. The automatic tying machine of claim 1, wherein the fastening slot (421) is fastened onto the rotating gear (420) and is spaced by a gap for receiving the tying string under the rotating slot (421′), wherein the rotating slot (421′) is formed on the rotating gear (420) and over the fastening slot (421) to pivot on a pivot shaft (427), wherein the rotating slot (421′) includes a tying string guide support (424) and a tying string compressing part (425) to prevent the tying string from sliding off when the tying string is wound around the crop, bundle, or bundled product, and wherein a stopper (426) is provided to control rotation of the rotating slot (421′).

3. The automatic tying machine of claim 2, wherein the rotating slot (421′) is rotated to fit the thickness of the tying string to thereby guide various thicknesses of tying strings, and wherein the rotating slot (421′) compresses the tying string by the tying string compressing part (425) to prevent the tying string from sliding off.
